(19) United States
(12) Patent Application Publication
(10) Pub. No.: US 2010/0116215 A1
(43) Pub. Date: May 13, 2010

(54) WHEAT BLEND SORBENT COMPOSITION

(76) Inventor: Mark Hughes, Detroit Lakes, MN (US)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/268,830

(22) Filed: Nov. 11, 2008

(51) Int. Cl. A01K 29/00

(52) U.S. Cl. 119/171

(57) ABSTRACT

The present invention discloses a natural pellet or crumbled pellet sorbent composition, as well as methods of making and using the composition to sorb a liquid. The sorbent is a mixture of a ground grain other than barley present at about 50% to about 99% by weight, and one or both of wheat middlings and barley, either of which can individually be present at up to about 50% by weight or both can be present at a total of up to about 50% by weight.

### FIELD OF THE INVENTION

The present invention pertains to a natural product composition and a method for use of the composition as a sorbent for liquids. More particularly, this invention refers to a wheat blend sorbent.

### BACKGROUND OF THE INVENTION

The use of litter as a sorbent for pet animal urine and other waste liquids has been known for years. Typically, the litter is placed into a container or in an area in which the pet has been trained to use for urinating and defecating. Many prior art litters have been derived from sand, clay, and other minimally sorbent materials. More recently, the useful life and sorbency of these litters has been increased by the addition of binders and other additives, which cause a clump to form when contacted by urine and fecal liquids. See e.g., U.S. Pat. No. 5,216,980 and No. 5,176,107. Formation of the soiled litter into a clump, in part, minimizes the spread of urine or fecal liquids, thus minimizing contamination of the unsoiled litter surrounding the excreted waste liquids. Additionally, clumping reduces the tracking of the soiled litter out of the litter container.

Recently, natural products (grains) and cellulosic products (sawdust, woodchips and plant hulls) have been used as litter. See e.g., U.S. Pat. No. 4,206,718; No. 4,727,824; No. 4,883,021; No. 5,109,804; No. 5,152,250; No. 5,690,052; and No. 6,014,947. These natural product litters were developed in an effort to enhance the sorbency of litter as well as to provide a biodegradable litter. Litters with greater sorbency can minimize odors, decrease the amount of litter required to sorb, and minimize disposal problems of the wetted litter. Although highly sorbent litters have been prepared, many of them swell excessively when contacted with liquids. This causes problems such as blockage of sewer or septic lines when the soiled litter is flushed down a toilet.

The present invention is directed to a highly sorbent, natural product litter with low swelling and suitable clumping characteristics. The invention also provides methods for using the natural product litter as a sorbent.

### BRIEF SUMMARY OF THE INVENTION

The present invention provides an improved natural product sorbent composition comprising a mixture of ground grains or a mixture of ground grains and wheat middlings.

One embodiment of this invention contemplates a pellet or crumbled pellet sorbent composition comprising a mixture of a ground grain other than barley present at about 50% to about 99% by weight, and one or both of wheat middlings and barley, either of which can individually be present at up to about 50% by weight or both can be present at a total of up to about 50% by weight. Preferably, the ground grain other than barley in the sorbent composition is wheat. More preferably, the wheat is selected from the group consisting of durum, hard red spring, hard red winter, hard white, soft white, and combinations thereof. Most preferably, the wheat is hard red spring wheat. A preferred particle size of the ground wheat is preferably about 4 mm to about 0.125 mm. This sorbent composition most preferably comprises about 50% ground wheat and about 50% barley by weight.

In another embodiment, the sorbent composition comprises a mixture of ground wheat and wheat middlings, wherein the ground wheat is present at about 50% to about 99% by weight and wheat middlings are present at about 1% to about 50% by weight. As above, the ground wheat is selected from the group consisting of durum, hard red spring, hard red winter, soft red winter, hard white, soft white and combinations thereof. Preferably, the ground wheat is hard red spring wheat and the ground wheat and wheat middlings have a particle size of about 4 mm to about 0.125 mm. The ground wheat and wheat middlings can also have a particle size of less than about 4 mm. The sorbent composition preferably comprises about 80% to about 85% ground wheat and about 20% to about 15% wheat middlings by weight.

In yet another embodiment, the sorbent composition comprised of ground wheat and wheat middlings further comprises about 1% to about 40% by weight barley. In this embodiment, preferably ground wheat is present at about 50% to about 98% by weight, wheat middlings are present at about 1% to about 10% by weight, and barley is present at about 1% to about 40% by weight. More preferably, the sorbent composition comprises about 80% ground wheat, about 10% wheat middlings, and about 10% barley by weight. The sorbent composition sorbs an amount of liquid at about 0.5 times to about 5.0 times the weight of the sorbent composition.

In still another embodiment, a method for sorbing a liquid is contemplated. Here, the method comprises the steps of providing a pellet or crumbled pellet sorbent composition as described above. That sorbent composition is contacted with a liquid to be sorbed. That contact is maintained for a time period sufficient for the liquid to be sorbed. Illustrative sorbent compositions for use in a contemplated method are discussed above and hereinafter. The ground wheat is preferably hard red spring wheat. The ground wheat and wheat middlings have a particle size of about 4 mm to about 0.125 mm.

In any of the embodiments, an additive selected from the group consisting of deodorants, microbial inhibitors, anti-dusting agents, animal attractants, odor neutralizers, and odor masking agents can be added to the sorbent composition.

### DETAILED DESCRIPTION OF THE INVENTION

The present invention provides an improved natural product sorbent composition and methods for sorbing liquids. The sorbent composition can be either a mixture of ground grains or a mixture of one or more ground grains and wheat middlings.

Wheat middlings, a co-product of wheat processing, are generally known as the organic material that remains after the milling of wheat grain and the resulting extraction of wheat flour. The composition of wheat middlings is somewhat variable depending upon the quality of the parent grains, the specific mill operation, and the desired final wheat product.

A ground grain of the invention can be prepared from cereal grains such as wheat, sorghum, barley, rice, oats, rye, triticale, millet, corn and other grains for which “cereal grain” is a generic term. The ground grain can be prepared from a single grain or combination of grains. The grains can be combined before or after the grinding process.

Preferred cereal grains of the invention are selected from the group of wheat varieties including hard white wheat, soft white wheat, hard red spring wheat, hard red winter wheat, soft red winter wheat, durum and combinations thereof. In one preferred embodiment, the ground grain is hard red spring wheat. In another preferred embodiment, the ground hard red spring wheat is combined with feed barley. In yet another embodiment, wheat middlings are also added to the hard red spring wheat and barley.

The ground grain is prepared by grinding whole raw grain. Prior to grinding, the whole raw grain can be put through a cleaning device to remove foreign materials including stones, rocks, metal, dirt, dust, weed seed and other non-grain material. Such cleaning devices are known in the art and include, for example, magnets, disk cleaning mills, sieve cleaning mills and similar devices. The grain can then optimally be subjected to disinfestation using an infestation destroyer. The order in which the grain is cleaned and disinfested is not important. Infestation destroyers are known in the art.

After the grain is cleaned and disinfested, it is subjected to a roller or a hammer mill to crush the whole grain into smaller particles. After the grain is crushed (ground) it moves into a sifter where small particles are separated by passing through a mesh sieve and the larger particles are returned to the roller or hammer mill until the proper particle size is achieved. Typically, the particle size is reduced such that at least about 95% of the particles are less than about 4 mm (pass through a 5 mesh screen). Preferably, at least about 95% of the particles are about 4 mm and about 0.125 mm (pass through a 5 mesh screen but not a 120 mesh screen).

The feed barley is similarly cleaned and sized though it is preferably not ground. The barley kernel is cleaned of the outer shell and thinly sliced so the brown color is removed.

Preferably, the sorbent composition has low odor and is biodegradable. Upon contact with a liquid, the sorbent can form a low attrition clump that is easily separated from the surrounding unwetted sorbent. When the sorbent is disposed of down a toilet, the clumps typically break apart. The sorbent typically has a low tendency to swell, thus reducing the likelihood of plugging a sewer or septic system upon disposal.

One aspect of the invention provides a pellet or crumbled pellet sorbent composition comprising a mixture of about 1% to about 50% by weight barley and about 50% to about 99% by weight of a ground grain other than barley. Preferably, in the sorbent composition the ground grain is wheat. More preferably, in the sorbent composition of the invention, the wheat is selected from the group consisting of durum, hard red spring, hard red winter, hard white, soft white, and combinations thereof. Most preferably, in the sorbent composition, the wheat is hard red spring wheat. This sorbent composition preferably comprises about 50% ground wheat and about 50% barley by weight.

In another embodiment, the sorbent composition comprises a mixture of ground wheat and wheat middlings, wherein the ground wheat is present at about 50% to about 99% by weight and wheat middlings are present at about 1% to about 50% by weight. Preferably, the ground wheat and wheat middlings have a particle size of about 4 mm to about 0.125 mm. The ground wheat and wheat middlings can also have a particle size of less than about 4 mm. The sorbent composition preferably comprises about 80% to about 85% ground wheat and about 20% to about 15% wheat middlings by weight.

In another embodiment, a sorbent composition comprised of ground wheat and wheat middlings further comprises about 1% to about 40% by weight barley. In this embodiment, preferably ground wheat is present at about 50% to about 98% by weight, wheat middlings are present at about 1% to about 10% by weight, and barley is present at about 1% to about 40% by weight. More preferably, the sorbent composition comprises about 80% ground wheat, about 10% wheat middlings, and about 10% ground barley by weight.

A contemplated sorbent composition is preferably in the form of a pellet or crumbled pellet. As such, a pellet or crumbled pellet sorbent composition comprises a mixture of a ground grain other than barley present at about 50% to about 99% by weight, and one or both of wheat middlings and barley, either of which can singly be present at up to about 50% by weight or both can be present at a total of up to about 50% by weight. One particularly preferred pellet or crumbled pellet sorbent composition contains substantially only (consists essentially of) a ground grain other than barley, and one or both of wheat middlings and barley in the amounts noted above.

Additives can be present in any of the sorbent compositions including, for example, deodorants, agents to inhibit microbial growth, anti-dusting agents, and animal attractants. Additives to mask or neutralize odors, for example, can be charcoal, baking soda, or natural products oils such as NILecho™ (a natural product oil product containing 50 natural oils sold by Nilodor, Inc., Bolivar, Ohio). Animal attractants, for example, can be natural proteins such as wheat or catnip. Anti-dusting agents, for example, can be a vegetable oil such as soybean oil or olive oil.

In another embodiment, a method for sorbing a liquid is contemplated. Here, a before-described pellet or crumbled pellet sorbent composition is provided, such as a composition comprising about 50% to about 99% ground wheat by weight and about 1% to about 50% wheat middlings by weight. The pellet or crumbled pellet sorbent is contacted with a liquid to be sorbed such as water, urine or oil, and that contact is maintained for a time period sufficient for the liquid to be sorbed. That time period can range from a few seconds to hours, particularly where the liquid is very viscous.

In this embodiment, the composition preferably comprises about 80 to about 85% ground wheat and about 20 to about 15% wheat middlings by weight. More preferably, the composition comprises about 80% ground wheat and about 20% wheat middlings by weight. The ground wheat is preferably hard red spring wheat. The ground wheat and wheat middlings have a particle size of about 4 mm to about 0.125 mm.

In any of the embodiments discussed herein, the sorbent composition can sorb an amount of liquid based on weight of about 0.5 times and about 5.0 times the weight of the sorbent. Typically, the sorbent composition can sorb an amount of a water-based liquid such as urine equal to at least its own weight, preferably at least 1.5 times its own weight, and more preferably at least 2.0 times the weight of the litter mixture as it is supplied in its packaging. Sorption amounts of other liquids such as oils and greases vary with the material being sorbed.

As used herein, “sorption” includes both adsorption and absorption of the liquid into or onto the sorbent. Sorbency can be measured using ASTM Standard F 726-99 (published in 1999) for a Type II sorbent. Water is placed in the test cell, a glass crystallizing dish. A sample of the sorbent is weighed, placed in a wire mesh basket (27 mesh size—0.063″-0.16 cm) and lowered into the test cell. Some of the sorbent typically floats within the test cell. After 15 minutes, the sorbent is removed from the water using the mesh basket. The basket is permitted to drain for 30 minutes. The sorbent is weighed again to calculate the amount of liquid sorbed.

A sorbent composition of the invention tends to form a low attrition clump upon contact with liquids. The phrase “low attrition clump” means a clump that, after drying, loses less than about 15% of its weight and preferably less than about 10% of its weight when subjected to attrition testing. Attrition testing involves wetting an excess of the litter mixture with 6 grams of water and permitting the sorbed water/litter admixture to set for 10 to 15 minutes. An “excess of litter mixture” means an amount in excess of an amount needed to sorb the 6 grams of water added. The clumps that form are carefully removed from the non-wetted litter and dried. The dried clumps are weighed. Then the bonded but poorly adhered litter on the surface of the clumps is removed by gently rubbing a finger across the surface. The removed litter is weighed to calculate the percent weight loss. The percent weight loss is the percent attrition.

Low attrition clumps are advantageous because they are less likely to lose particles of soiled litter when the clump is removed from the surrounding unsoiled litter in a litter container. A low attrition clump can provide a significant advantage by increasing the useful life of the litter through decreased contamination of the unsoiled litter by soiled litter falling away from the clump. Additionally, clumping prevents particles from breaking off of a soiled clump if subjected to compression by an animal stepping on the clumps while moving around in the litter. The tracking of the litter outside the litter container can be minimized.

The sorbent composition tends to swell less than some other natural product litters. As used herein, “swell” means the tendency of the litter to increase in volume when contacted with a liquid. This attribute is particularly beneficial if the soiled litter is flushed down a commode attached to a sewer or septic system. By using a litter that swells less upon contact with liquids, sewer or septic systems have fewer tendencies to become blocked or plugged when the litter is flushed down a toilet. Additionally, because the litter is made of biodegradable materials, used litter that is flushed into a sewer system or septic system breaks down readily to produce soluble biological products.

A litter that swells 100% means that the sorbent doubles in volume upon contact with the water. A composition of this invention typically swells less than about 10% based on the volume of the sorbent. The sorbent preferably has no volume change on exposure to a liquid and most preferably shrinks upon contact with liquid.

The selected ground grain and one or both of wheat middlings and barley are mixed to form a homogeneous litter mixture. Suitable mixing equipment includes, for example, ribbon or paddle mixers. The homogeneity can be determined visually based on color similarity and color uniformity for samples taken from several locations in the mixing vessel.

One embodiment of the invention provides a pelletized litter. A typical pelletizer has a feeder for the dry components and a conditioner where liquids are added. The conditioned material then flows into the pelleting chamber where the pellet is formed. Varying the compression ratio, moisture content and temperature during pelletization can alter the product characteristics. The compression ratio is typically about 4:1 to about 9:1. Preferably, the compression ratio is about 5:1 to about 9:1 and most preferably about 5:1 to about 8:1. Poor pellets containing a large number of fines are typically formed at a compression ratio less than about 4:1. The product characteristics can be difficult to reproduce when compression ratios less than about 5:1 are used. Higher amounts of water are needed to form pellets with a compression ratio of 5:1 or less. This amount of water is disadvantageous because more drying of the pellet is required after formation. Good pellets can be formed with smaller amounts of added water at compression ratios greater than about 5:1.

The moisture required for pelletization can be added during the mixing step of the ground grain and wheat middlings, after the mixing step but in the same vessel used for mixing, or as part of the pelletization process. Preferably, the moisture is added as part of the pelletization process. The moisture can be added as liquid water, but is preferably added in the form of steam that comes from a boiler that can otherwise be used to heat the materials during pelletization. The steam can be provided at atmospheric pressure or at an elevated temperature at a pressure above one atmosphere. The steam also can heat the mixture to about 165° F. to about 175° F. (about 75° C. to about 80° C.).

Lower levels of moisture addition are preferred to minimize the amount of drying required after pelletization. Typically, the moisture content of the litter after mixing is about 7 weight percent to about 14 weight percent based on the weight of the litter. Preferably, the moisture level during pelletization is less than about 15 weight percent and more preferably less than about 13 weight percent based on the weight of the litter. When compression ratios of 5:1 or less are used, the total water needed to form pellets is about 15 weight percent to about 18 weight percent based on the weight of the litter.

Greater amounts of water are needed to form pellets with a compression ratio of 5:1 or less. This amount of water is disadvantageous because more drying of the pellet is required after formation. Good pellets can be formed with smaller amounts of added water at compression ratios great than about 5:1.

The pelletization temperature preferably is about 140 to about 175° F. (about 60° to about 80° C.). The use of temperatures at or above 80° C. were avoided in previously used pelletization processes using other materials such as those used in preparing the pellets of U.S. Pat. No. 6,568,349. In that previous process, higher temperatures tended to produce pellets with hard shells reducing the sorbency of the litter. With a present litter composition, the use of higher temperatures helps the process run more smoothly without the adverse effect of producing hard shells on the pellets. The ideal temperature is about 155° F. for the pellatized material as it emerges from the machine.

If the ground grain is wheat, temperatures in excess of about 180° F. (82° C.) can cause gelatinization and decrease the ability of the litter to clump upon exposure to a liquid. Preferably, the pelletization temperature of the grain-containing mixture is about 140° F. (43° C.) to about 170° F. (77° F.). More preferably, the temperature of the mixture during pelletization is about 155° F. (54° C.).

After formation, the pellets can be dried, for example, in a cooler or a dryer. Cooling can occur by air movement created by a fan. The dryer can be, for example, a fluid bed dryer. Drying can be done in the presence of air or an inert gas. The temperature of the gas exiting the dryer is typically less than 180° F. (82° C.). The final moisture typically is less than about 12 weight percent, preferably less than about 11 weight percent and more preferably less than about 9 weight percent. Lower moisture content minimizes microbial growth in the final product.

Any fines produced can be returned to the pelletizer for re-processing. The typical bulk density of the pellets is about 0.40 g/cc to about 0.80 g/cc. In one embodiment, the preferred bulk density is about 0.50 g/cc to 0.65 g/cc.

The pellet can be any size that provides the desired sorbency function. Typically, the pellet diameter is about ⅛″ (0.32 cm) to about ½″ (1.28 cm) and preferably about 5/32″ (0.40 cm) to about ¼″ (0.64 cm). The pellet length typically is about ⅔″ (1.70 cm) to about ⅓″ (0.85 cm) and preferably about ½″ (1.28 cm) to about 7/16″ (1.11 cm). Substantially spherical particles can also be produced that have diameters of about ⅛″ (0.32 cm) to about ⅔″ (1.70 cm), and more preferably about 5/32″ (0.40 cm) to about 7/16″ (1.11 cm).

In another embodiment, the pelletized litter can be crumbled. Crumbling is a process of milling the pelletized litter in a crumbler or roller mill to produce smaller particles. The gap between the rolls determines the size of the crumbled product. Typical crumbling is such that a pellet is reduced from about one-fourth to about three-fourths and preferably from about one-half to about two-thirds of the original pellet size. The objective of crumbling is to reduce the size of the pellets without creating a large number of fines. The crumbled litter typically can sorb an amount of liquid based on the out of package litter weight that is about 0.5 times to about 5.0 times the weight of the litter.

Another embodiment of the invention is a method of sorbing liquids using a sorbent comprising a mixture of ground grain and one or both of wheat middlings and barley. A previously described litter is contacted with a liquid to be sorbed and the contact is maintained for a time sufficient to sorb the liquid. It is to be understood that the times sufficient to sorb is dependent on the physical attributes of the liquid to be sorbed and also the amount of that liquid. As one example, about 10 ml of cat urine would take approximately 10 minutes to be nearly completely sorbed by about 100 grams of litter.

The following examples further describe the method for preparing a ground grain litter of the invention and the tests performed to determine the various characteristics of the litter. The following examples are provided for exemplary purposes to facilitate understanding of the inventions and should not be construed to limit the invention to the examples.

### EXAMPLES

### Example 1

### Pelleting of Sorbent Compositions

Five samples were ground, blended where applicable, and pelleted. Each sample consisted of approximately 100 pounds. Sample 1 consisted of 100% ground spring wheat to serve as a control; Sample 2 was a blend of 80% ground spring wheat with 20% wheat middlings by weight; Sample 3 was a blend of 85% ground spring wheat with 15% barley by weight; Sample 4 was a combination of all three products, 80% ground spring wheat, 10% wheat middlings, and 10% barley by weight; Sample 5 was a blend of 50% ground spring wheat with 50% ground barley by weight. Table 1 shows the pelleting details.

TABLE 1

| | | Temperature | | | |
|---|---|---|---|---|---|
| | H₂O Added | (° F.) | | Run | Pellet |
| Product | (%; Steam) | Start | Finish | Efficiency | Moisture |
| Wheat 100% | 2.6 | 60 | 146 | Excellent | 10.7 |
| Wheat 80% | 3.5 | 60 | 156 | Excellent | 10.4 |
| Middlings 20% | | | | | |
| Wheat 85% | 2.8 | 60 | 156 | Excellent | 9.5 |
| Barley 15% | | | | | |
| Wheat 80% | 3.0 | 50 | 165 | Excellent | 9.7 |
| Middlings 10% | | | | | |
| Barley 10% | | | | | |
| Wheat 50% | 2.0 | 60 | 161 | Excellent | 9.7 |
| Barley 50% | | | | | |

Die was 5/32″ X 8:1 for all Products

Sorbent blends were pelleted on a “Master” California Pellet Mill, 40 HP. Grain was ground using an 5/32″ diameter hole screen in a 25 Hp Jacobson hammer mill prior to pelleting. Prior to testing, the pellet die was pre heated. Pelleted test samples were crumbled on a Roskamp Champion roller mill. Rollers were set at 5/64″ or approximately half the width of the test pellet.

### Example 2

### Analysis of Sorbent Pellet Durability

Pellet durability was analyzed to determine consistency of pellets and to evaluate any potential effect pelleting may have on sorbent ability. The results are as follows:

TABLE 2

| Sample | | Pellet Durability |
|---|---|---|
| Number | Product | (%) |
| 1 | Wheat 100% | 85 |
| 2 | Wheat 80% | 97 |
| | Middlings 20% | |
| 3 | Wheat 85% | 96 |
| | Barley 15% | |
| 4 | Wheat 80% | 98 |
| | Middlings 10% | |
| | Barley 10% | |
| 5 | Wheat 50% | 94 |
| | Barley 50% | |

All pellet durabilities showed excellent pellet quality. The sample that included a mixture of wheat middlings and barley had improved pellet quality over wheat regardless to specific inclusion rates tested. Sample 5 resulted in a reduction of pellet durability with pellet temperatures very similar to those of Samples 2-4.

### Example 3

### Crumble Density of Sorbent Compositions

Product density was a concern due to limited bag size. Densities based on pounds per cubic foot were taken on pelleted and crumbled product. Results are shown in Table 3.

TABLE 3

| Sample | | Crumble Density |
|---|---|---|
| Number | Product | (lbs/ft³) |
| 1 | Wheat 100% | 40.7 |
| 2 | Wheat 80% | 38.7 |
| | Middlings 20% | |
| 3 | Wheat 85% | 40.8 |
| | Barley 15% | |
| 4 | Wheat 80% | 40.5 |
| | Middlings 10% | |
| | Barley 10% | |
| 5 | Wheat 50% | 39.9 |
| | Barley 50% | |

The inclusion of wheat middling caused a reduction in bulk density by approximately two pounds per cubic food after crumbling. Sample 4, which included wheat middlings at a 10% by weight inclusion, did not exhibit a significant reduction in density. The inclusion of barley did not make any significant difference in bulk density.

### Example 4

### Pellet Sorbency

Pellet and crumble sorbency are two of the main focuses of cat litter evaluation. Sorbent testing was performed following ASTM F-726 9.3.2. Table 4 illustrates pelleted wheat blends tested for their sorbency. Wheat (Sample 1) had the lowest pellet quality yet does not have the greatest sorbency capabilities. The same is true when evaluating Sample 4, which had the hardest pellet and did not have the lowest pellet sorbency.

TABLE 4
Pellet Sorbency

| Sample | | H₂O Sorbed/Product |
|---|---|---|
| Number | Product | (% g/g) |
| 1 | Wheat 100% | 56.9 |
| 2 | Wheat 80% | 55.5 |
| | Middlings 20% | |
| 3 | Wheat 85% | 46.1 |
| | Middlings 15% | |
| 4 | Wheat 80% | 51.6 |
| | Middlings 10% | |
| | Barley 10% | |
| 5 | Wheat 50% | 68.5 |
| | Barley 50% | |

### Example 5

### Crumble Sorbency

The second sorbency test conducted was on the crumbled product. Pellets were crumbled in a roller mill with the rollers set ½ the pellet width using 8″ rolls. Following are the sorbency results of the crumbled wheat blends (Table 5). Product fines were not sieved or separated from product.

TABLE 5
Crumble Sorbency

| Sample | | H₂O Sorbed/Product |
|---|---|---|
| Number | Product | (% g/g) |
| 1 | Wheat 100% | 154 |
| 2 | Wheat 80% | 183 |
| | Middlings 20% | |
| 3 | Wheat 85% | 154 |
| | Middlings 15% | |
| 4 | Wheat 80% | 160 |
| | Middlings 10% | |
| | Barley 10% | |
| 5 | Wheat 50% | 179 |
| | Barley 50% | |

The crumbled wheat blends showed increased sorbency. It can be assumed that wheat middlings improve product sorbent ability. An improvement in sorbency was seen over the 100% wheat control in both test blends with wheat middling inclusion. The utilization of barley also did not hinder wheat sorbency.

### Example 6

### Clumping Efficiency of Crumbled Wheat Blends

In correlation with litter sorbency, clumping efficiency and depth are also important characteristics of cat litter. Clumping efficiency is defined as the amount of litter material required to sorb 5 ml of water. This test involved the crumbled wheat blends. Samples are placed into a glass dish and filled 4″ deep with litter. Five milliliters of water is then added to the samples and the samples are allowed to sorb for thirty minutes. The resulting clump of sample is then removed and weighed. In this case, a lower amount of product required to bind 5 ml (6.42 g) of liquid represent a more sorbent product (Table 6).

TABLE 6

| Sample | | Weight of Wetted |
|---|---|---|
| Number | Product | Sample (g) |
| 1 | Wheat 100% | 19.2 |
| 2 | Wheat 80% | 20.7 |
| | Middlings 20% | |
| 3 | Wheat 85% | 24.5 |
| | Middlings 15% | |
| 4 | Wheat 80% | 23.2 |
| | Middlings 10% | |
| | Barley 10% | |
| 5 | Wheat 50% | 24.5 |
| | Barley 50% | |

Clumping results indicate that 100% wheat litter is the most efficient at forming a clump. However there is not a significant difference due to the inclusion of wheat middlings. It is assumed that barley had a lower clumping efficiency due to product weight.

### Example 7

### Clumping Depth of Crumbled Wheat Blends

Depth of the litter clump required to sorb 5 ml of water was also evaluated to provide additional information for comparing performance characteristics of an all wheat litter to a wheat blend litter.

TABLE 7
Clumping Depth of Crumbled Wheat Blends

| Sample | | Clumping Depth |
|---|---|---|
| Number | Product | (Inches) |
| 1 | Wheat 100% | 1.1 |
| 2 | Wheat 80% | 1.7 |
| | Middlings 20% | |
| 3 | Wheat 85% | 1.55 |
| | Middlings 15% | |
| 4 | Wheat 80% | 2.52 |
| | Middlings 10% | |
| | Barley 10% | |
| 5 | Wheat 50% | 2.7 |
| | Barley 50% | |

Results were not conclusive. The inclusion of middlings and barley produced a deeper litter clump than 100% wheat; yet the greater inclusion of barley and the middlings and barley combination created a very deep litter clump which can be viewed as a negative characteristic as compared to the 100% wheat litter. One variable not taken into account is the percent ‘dust’ or ‘fines’ in each of the crumbled litters evaluated.

### Example 8

### Ammonia Control of Crumbled Wheat Blends

Ammonia control was the final test conducted. The ability of wheat to mask or control the release of ammonia is a critical characteristics required in cat litter. Tests conducted utilized ammonium hydroxide to evaluate litter performance. Ammonium hydroxide is a very concentrated form of ammonia. Concentration levels exceeded equipment measuring capabilities of 70 parts per million (ppm) ammonia. Testing was conducted utilizing a Dragger air monitor and ammonia test tubes with the capacity to read 0.25-70 ppm ammonia. Testing involved applying 5 ml of ammonium hydroxide to 4 inches of crumbled material. Results are shown in Table 8.

TABLE 8
Litter Ammonia Control Test

| | |
|---|---|
| Sample | Ammonia Concentration (ppm) |

| Number | Product | 10 Minutes | 20 Hours |
|---|---|---|---|
| 1 | Wheat 100% | 49 | 2.5 |
| 2 | Wheat 80% | 47 | 2 |
| | Middlings 20% | | |
| 3 | Wheat 85% | 51 | 2.25 |
| | Middlings 15% | | |
| 4 | Wheat 80% | >70 | 1.9 |
| | Middlings 10% | | |
| | Barley 10% | | |
| 5 | Wheat 50% | >70 | 2.5 |
| | Barley 50% | | |

All wheat blends effectively and significantly mask ammonia by 20 hours.

From the foregoing detailed description it will be evident that modification can be made in the compositions and methods of the invention without departing from the spirit or scope of the invention. Therefore, it is intended that all modifications and variations not departing from the spirit of the invention come within the scope of the claims and their equivalents.

Each of the patents and articles cited herein is incorporated by reference. The use of the article “a” or “and” is intended to include one or more.

1. A pellet or crumbled pellet sorbent composition comprising a mixture of a ground grain other than barley present at about 50% to about 99% by weight, and one or both of wheat middlings and barley, either of which can individually be present at up to about 50% by weight or both can be present at a total of up to about 50% by weight.

2. The sorbent composition of claim 1, wherein the ground grain other than barley is wheat.

3. The sorbent composition of claim 2, wherein the wheat is selected from the group consisting of durum, hard red spring, hard red winter, hard white, soft white, and combinations thereof.

4. The sorbent composition of claim 2, wherein the ground wheat is hard red spring wheat.

5. The sorbent composition of claim 2, wherein the ground wheat has a particle size of about 4 mm to about 0.125 mm.

6. The sorbent composition of claim 3, wherein the composition comprises about 50% ground wheat and about 50% barley by weight.

7. The sorbent composition of claim 3, wherein the ground wheat is present at about 50% to about 99% by weight and wheat middlings are present at about 1% to about 50% by weight.

8. The sorbent composition of claim 7, wherein the ground wheat and wheat middlings have a particle size of less than about 4 mm.

9. The sorbent composition of claim 8, wherein the composition comprises about 80% to about 85% ground wheat and about 20% to about 15% wheat middlings by weight.

10. The sorbent composition of claim 7, further comprising about 1% to about 40% by weight barley.

11. The sorbent composition of claim 10, wherein ground wheat is present at about 50% to about 98% by weight, wheat middlings are present at about 1% to about 10% by weight, and barley is present at about 1% to about 40% by weight.

12. The sorbent composition of claim 10, wherein the composition comprises about 80% ground wheat, about 10% wheat middlings, and about 10% barley by weight.

13. The sorbent composition of claim 12, wherein an additive selected from the group consisting of deodorants, microbial inhibitors, anti-dusting agents, animal attractants, odor neutralizers, and odor masking agents is added to the sorbent composition.

14. The sorbent composition of claim 12, wherein the sorbent composition sorbs an amount of liquid equal to about 0.5 to about 5.0 times the weight of the sorbent composition.

15. A method for sorbing a liquid comprising the steps of:
a) providing a pellet or crumbled pellet sorbent composition of claim 1;
b) contacting the sorbent composition with a liquid to be sorbed, and
(c) maintaining that contact for a time period for the liquid to be sorbed.

16. The method of claim 15, wherein the ground grain other than barley is wheat.

17. The method of claim 16, wherein the composition comprises about 80% to about 85% ground wheat and about 20% to about 15% wheat middlings by weight.

18. The method of claim 16, wherein the ground wheat is hard red spring wheat.

19. The method of claim 16, wherein the ground wheat and wheat middlings have a particle size of about 4 mm to about 0.125 mm.

20. The method of claim 16, wherein an additive selected from the group consisting of deodorants, microbial inhibitors, anti-dusting agents, animal attractants, odor neutralizers, and odor masking agents is added to the sorbent composition.

21. The method of claim 16, wherein the sorbent composition further comprises about 1% to about 40% by weight barley.

22. The method of claim 16, wherein ground wheat is present at about 50% to about 98% by weight, wheat middlings are present at about 1% to about 10% by weight, and barley is present at about 1% to about 40% by weight.

23. The method of claim 16, wherein the sorbent composition comprises about 80% ground wheat, about 10% wheat middlings, and about 10% ground barley by weight.

24. The method of claim 16, wherein the sorbent composition comprises about 50% to about 99% ground wheat by weight and about 1% to about 50% barley by weight.

25. The method of claim 24, wherein the composition comprises about 50% ground wheat and about 50% barley by weight.

26. The method of claim 24 wherein the ground wheat is hard red spring wheat.

27. The method of claim 16 wherein the sorbent composition sorbs an amount of liquid equal to about 0.5 to about 5.0 times the weight of the sorbent.
